(19) United States
(12) Patent Application Publication
(10) Pub. No.: US 2020/0331741 A1
(43) Pub. Date: Oct. 22, 2020

(54) BEVERAGE BOTTLE HANDLING SYSTEM FOR HANDLING BEVERAGE BOTTLES AND SIMILAR CONTAINERS

(71) Applicants: Carsten BUCHWALD, Bad Breisig (DE); Jürgen-Peter HERRMANN, Rosenheim (DE); Marius Michael HERRMANN, Rosenheim (DE); Wolfgang SCHORN, Hönningen (DE)

(72) Inventors: Carsten BUCHWALD, Bad Breisig (DE); Jürgen-Peter HERRMANN, Rosenheim (DE); Marius Michael HERRMANN, Rosenheim (DE); Wolfgang SCHORN, Hönningen (DE)

(21) Appl. No.: 16/387,718

(22) Filed: Apr. 18, 2019

(51) Int. Cl. B67C 3/24; B67C 3/00; B65C 9/04; B65C 9/26; B65C 3/14; B65G 47/84

(52) U.S. Cl. CPC B67C 3/24; B67C 3/007; B65C 9/04; B65G 2201/0244; B65C 3/14; B65G 47/846; B65C 9/26

(57) ABSTRACT

A beverage bottle handling system designed to handle beverage bottles and similar containers, and which includes a beverage bottle inspection arrangement to be connected to a rotatable transport star.

### BACKGROUND

### 1. Technical Field

The present application relates to a beverage bottle handling system for handling beverage bottles and similar containers.

### 2. Background Information

Background information is for informational purposes only and does not necessarily admit that subsequently mentioned information and publications are prior art.

Some beverage bottle handling devices, such as disclosed in EP 2290355 incorporated by reference herein, comprise a straight conveyor belt for continuously conveying labeled bottles or other vessels made of glass, plastic, or another suitable translucent material.

The lateral surfaces of the bottles are in each case fully enclosed by a label, in particular by a shrunk-on foil label, which conforms closely to the outer contours of the bottle. The label may consist of an at least partially transparent plastic film, for example made of PE or PP, which is provided with a product and/or bottle-dependent imprint.

The application also relates to an inspection device for containers and in particular for bottles or other vessels, as discussed in EP 1985997, which is incorporated by reference herein. Such devices are known from the prior art and serve, for example, to examine moving containers on a conveyor belt and in particular bottles during the movement. One aspect of such examinations is, for example, whether a label attached to the bottles is currently sitting or whether it has warps, wrinkles or the like.

In beverage bottling, labels and relief-like embossments on bottles, so-called embossings, are usually aligned as exactly as possible with each other, as is discussed in EP 2251678, which is incorporated by reference herein. As is known, this is achieved by placing the filled bottles on a rotatable centering device in a defined initial rotational position prior to labeling, the embossings being localized by rotating the bottle surface in front of a camera unit. However, both the seating of the bottles on the alignment cams of the centering devices and the drive of the centering devices cause inaccuracies, so that individual labels may not be able to be applied with the required accuracy.

Another problem, according to DE 102007054657, which is incorporated by reference herein, is the reliable detection of bottle levels in practice. So it is necessary to detect and discard non-filled or poorly filled bottles in production or possibly stop the process to correct the problem. The detection of the level in transparent bottles is particularly problematic when a label is placed on the neck of the bottle. Problems can also occur with the bottle or bottles not yet closed, since the closure in the opened state can be in the range of the filling limit or of the upper filling level. Further uncertainties in the level detection can occur in bottles with structured bottlenecks, since here an optical image of the level can be more or less distorted.

The specimens may in particular be filled and sealed or unsealed bottles. Preferably, the bottles are visualized in their head and/or shoulder area or imaged on the image recording element. By means of the image evaluation device, the fill levels of the bottle can be evaluated. The bottles are typically moved at high speed through a conveyor system and conveyed past the arrangement according to the invention. Here the sample body or bottles are always at the same height, so that the fill levels or other parameters can be reliably recorded and evaluated with a fixed recording and evaluation device.

U.S. Pat. No. 5,729,340, which is incorporated by reference herein, discusses a machine for inspecting bottles or the like through which light can be transmitted. In beverage bottling lines, inspection machines are used to detect and eliminate damaged or dirty bottles before they reach a bottle filling machine. Most pre-existing bottle filling machines require rotation of each bottle about its vertical axis while a thin vertically extensive light beam passes through the bottle for a projected image of the bottle sidewalls to be recorded. During rotation, substantially only the center of the bottle is currently recorded along a vertical line. A line scan camera may be used. The image of the bottle sidewall obtained is of sufficient quality to reveal or detect bottles that are damaged or dirty. In the pre-existing machine just outlined, rotation of the bottles as they arrive in the inspection zone requires that the bottles be mounted on rotationally driven plates that are carried on a carousel that has the mechanism for rotating the plates. This is a complicated and expensive structural arrangement which it would be desirable to avoid.

The present application relates to a light transmission inspection device for detecting structures of a container, such as a bottle. The present application also relates to an inspection system for detecting defects in structures of containers, such as beverage bottles, using a light transmission system configured to transmit light through a portion of a bottle.

Inspection devices for detecting structures, such as, for example, profilings or embossings on a container, are known. Both specifications disclose cambered configured lighting elements of elaborate design, which illuminate the lighting body. The light beams reflected from the bottle are detected by a camera, and an evaluation of the light beams reflected from the camera is then carried out by way of a control or detection unit. In this situation the reflection pattern from, for example, embossed container wall regions differ perceptibly from the usual reflection patterns from the non-embossed container wall.

The cambered configuration requires and/or desires a large structural space, which therefore renders the use of the device difficult in the region of a transport system, for example, with which the bottles are transported on a circular track.

Added to this is the fact that, with the movement of the containers on the circular track, and due to the transition speed of the bottles, centrifugal forces are incurred, due to which the container, during transport in the transport star, is not held fully perpendicular or substantially perpendicular in respect of its mid-axis, but is deflected out of its perpendicular or substantially perpendicular position. The interpretation of the light beams reflected from the camera is therefore frequently imprecise, since no information is available regarding the exact or substantially exact or general position of the bottle at the moment of the pick-up.

### OBJECT OR OBJECTS

The present application seeks to disclosed a beverage bottle handling system for improved handling of beverage bottles and similar containers.

### SUMMARY

Further exemplifications of the present application are presented in the present application. In this context, the features described are in principle the object of the present application, taken alone or in any combination, regardless of their relationship in the claims or reference to them.

The present application is based on an object of providing an improved beverage bottling handling system, particularly an inspection device for the detecting of structures of a container during its movement on a transport track. The present application solves the object by a light transmission inspection device according to the present application. The light transmission inspection device according to the present application for detecting structures of a container, such as a beverage bottle, comprises a lighting unit arranged at one side of a transport path for the container for transilluminating at least one container portion, and an optical unit arranged on a second side of the transport path for detecting a transmitted light image of the container portion, wherein a lens is arranged at the lighting unit for the alignment of the light beams emitted by the lighting unit.

At the detection of the transmitted light image of the container or container segment, a structure shadow image of the container is detected. In this situation, the light cast onto the container by the lighting unit is absorbed by, in at least one possible exemplification, light-permeable regions of the container perceptibly less than by regions of the container which are light-permeable. Accordingly, for example, the outer edges of the container are perceived (detected) as dark shadows with particular and/or relative precision. It is also possible for indentations, embossings, or also thickened regions of the container to be detected in at least one possible exemplification well. Accordingly, for example, the bottle neck and, in at least one possible exemplification, the mouth of the bottle, can be detected in at least one possible exemplification clearly by the optical unit. In addition to this, by the detection of the mouth region of the container and/or the outer outlines of the container, a possible oblique position, i.e. a deflection of the container out of a perpendicular or substantially perpendicular position, can be in at least one possible exemplification detected.

In this situation the lens supports the optical unit in such a way that the light impinges onto the container with particular or general alignment. As a result, for example, reflections can be avoided and/or restricted and/or minimized and the peripheral structures of the shadow image can be represented in at least one possible exemplification clearly (with a high sharpness of focus), as a result of which the detection precision of the optical unit is perceptibly improved.

The term “lenses” is to be understood in this situation as conventional lenses for the alignment of light beams, or also lens systems, i.e. a plurality of individual lenses which are connected one behind another. In at least one possible exemplification of the present application, the lens is a film lens. Such optical films serve to provide improved light scatter or light utilization (brightness enhancement film).

The film lens allows for a particularly or generally or relatively small structural space for the light transmission inspection device, as a result of which it is also possible, for example, for the light transmission inspection device to be arranged as integral to a container treatment station, such as a filling system, a labeling device, or a bottle seam identification system. Regardless of the structural form of the lens, the light transmission inspection device can alternatively also be arranged as a separate station in the course of the transport path of the container.

The alignment of the light beams is usually configured in such a way that the light beams enter at different angles and all or most or some emerge perpendicular or substantially perpendicular (parallel or substantially parallel) from the lens surface, such that a body (such as a container) will be impinged by the light beams and illuminated by transmitted light (transilluminated) as appropriate.

According to a further exemplification of the present application, provision is made for the lens to align the light beams in such a way that they emerge from the lens surface in two different spatial directions. The angle between the light beams can therefore be, for example, between ten degrees and one hundred seventy degrees, in one possible exemplification ninety degrees. in another possible exemplification, the light beams are refracted uniformly before the lens, such that the angle a between the lens surface and all or most or some of the light beams (regardless of the spatial direction) is of the same value. For this purpose, for example, in one possible exemplification of the present application, the film lens (brightness enhancement film) can be inserted in an inverse alignment, such that the light beams do not emerge parallel or substantially parallel, but, in the specified form of operation, such as described in the examples, the light emerges in two main directions at an angle of forty-five degrees. In at least one possible exemplification of the present application, if the light source is provided as an LED field, then in this way a particularly or generally or relatively narrow structural space can be maintained, and nevertheless, simultaneously or with minimal time displacement, two different perspectives of a container can be picked up.

The inverse arrangement of the film lens allows for the light to be deflected into a spatial direction which is not perpendicular or substantially perpendicular to the transport direction/path, and which produces a dark field before the film lens. In at least one possible exemplification, a film lens is used which refracts or deflects the light in such a way that the beams are not deflected parallel or substantially parallel and not perpendicular or substantially perpendicular to the transport path.

Advantageously, the light transmission inspection device is arranged in a container treatment device in such a way that the containers or the container portion is transilluminated by light beams which are emitted into both different spatial directions, such that two transmitted light images of the container are produced, which can be detected by the optical unit.

Inasmuch as the container, the optical unit, and the lighting unit, at the detection of the transmitted light images, are, for example, arranged uniformly in relation to one another, the transmitted light images are identical in location. That is to say, for example, that an edge of the container (in the region of the mouth) oriented horizontal in relation to the perpendicular or substantially perpendicular mid-axis of the container also appears horizontal in both transmitted light images.

However, inasmuch as the container is deflected out of its perpendicular or substantially perpendicular position, the transmitted light images of the container exhibit an inclination. So, for example, edges of the container arranged horizontal to the middle perpendicular or substantially perpendicular of the container likewise appear at an inclination in the transmitted light image.

So, for example, with a transillumination of the mouth region showing as oblique in two spatial directions, a closure edge of the mouth region appears to be inclined at an angle in every transmitted light image. In this situation, the inclination angles can be aligned, for example, mirror-symmetrical to one another.

Due to the inclination angles of the mouth regions of the container, appearing as inclined in both the transmitted light images, the deflection of the container out of its perpendicular or substantially perpendicular position can be determined in at least one possible exemplification easily or relatively easily.

The detection of the two transmitted light image of a container can be effected by separately arranged optical units. For this purpose any optical detection unit can be used, such as a camera. According to a further exemplification of the present application, however, provision is made for the optical unit to comprise a detection unit, in at least one possible exemplification a camera, and at least two beam deflection elements deflecting the light beams. As a result, it is possible also to detect light beams which are emitted in two different spatial directions by one optical unit.

The beam deflection elements are configured in at least one possible exemplification as deflection mirrors and/or deflection prisms. The arrangement of the beam deflection elements can be effected in such a way that the light beams emitted in two spatial directions, departing from the lighting unit, transilluminate the container, impinge onto the deflection mirrors, and are then deflected from these onto a deflection prism, and from the deflection prism into the camera.

According to a further exemplification of the present application, for the evaluation of the transmitted light image detected by the camera an evaluation unit is arranged, which compares a reference or target position and/or a reference or target marking of the container with an actual position and/or actual marking detected by the optical element.

Depending on the transilluminated region of the container, as already explained previously, the orientation of the container is determined in relation to its perpendicular or substantially perpendicular standing mid-axis. The positions of markings or also of a label on the container can be determined, in that the transmitted light image of the marking and/or of the label, if appropriate by taking account of the deflection of the container out of its perpendicular or substantially perpendicular position, is compared with a reference or target position/reference or target marking. In the event of deviations from the reference position/reference marking, the evaluation unit is advantageously supplemented by a control or detection unit, which moves the container into its reference position, or can also remove the container from the container stream by way of a lock arrangement.

In at least one possible exemplification of the present application, a bottle seam detection system with a second optical system is arranged for the detection of a container bottle seam. The second optical system is/can be configured as a camera and arranged perpendicularly or substantially perpendicuarly above or below the bottle, such that this camera can produce an image of the bottle base.

The problem with this situation is that, due to the centrifugal forces during the transport in the transport star, the bottles tilt out of the perpendicular or substantially perpendicular position. It is therefore not possible for a seam recognition system to determine the exact and/or general positioning of the bottle seam, since it does not know the tilt angle, i.e. the deflection of the bottle out of its perpendicular or substantially perpendicular.

By means of the light transmission inspection device according to the present application, it is possible to detect the deflection of the container, and, by means of a comparison of the image of the bottle seam detected by the second optical system, to determine its exact actual or general position on the bottle. In the event of a deviation of the bottle seam from the reference position, the bottle can then, for example, be guided out of the bottle stream.

The light transmission inspection device of the present application can, in one possible exemplification in its at least one possible exemplification compact exemplification, be arranged with a film lens on a container transport system or directly or integral with a processing station of the container treatment system. In this situation, the light transmission inspection device can be arranged in the region of a transport star, since the film lens allows for a particularly or generally or relatively small structural space for the light transmission inspection device.

In addition, it is also possible by means of the light transmission inspection device according to the present application for container structures, such as the bottle seam or the like, to be detected during the transport of the container in a transport star or also in a linear or curved transporter, such that no additional inspection stations need and/or desire to be arranged for this purpose in the transport path of the container.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 is a side elevational view of a circular glass bottle to be inspected;

FIG. 2 is a top plan view of the glass bottle of FIG. 1;

FIG. 3 is a top plan view similar to FIG. 2, illustrating a glass bottle which has an oval cross-sectional shape;

FIG. 4 shows an example of a beverage bottle handling machine;

FIG. 5 shows an example of a beverage bottle handling machine;

FIG. 6 shows another view of FIG. 5;

FIGS. 7 and 8 schematically, in a perspective representation, a possible exemplification of the light transmission inspection device;

FIG. 7A schematically shows in a perspective representation, a possible exemplification of the light transmission inspection device with a computer;

FIG. 9 schematically, in a view from above, the light transmission inspection device from FIGS. 7 and 8;

FIG. 10 schematically, in a transverse section, a section from the lighting unit and a film lens from FIGS. 7-9;

FIGS. 11 and 12 show an example of a beverage bottle inspection system;

FIG. 13 shows a first illustration of a portion of a bottle with an open strap closure;

FIG. 14 shows a second illustration of a portion of a bottle with an open strap closure; and

FIG. 15 shows a third illustration of a portion of a bottle with an open strap closure.

### DESCRIPTION OF EXEMPLIFICATION OR EXEMPLIFICATIONS

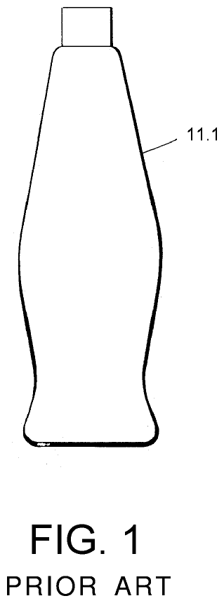

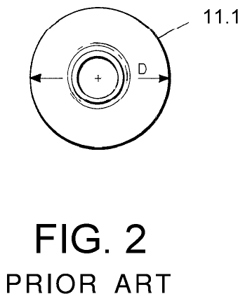

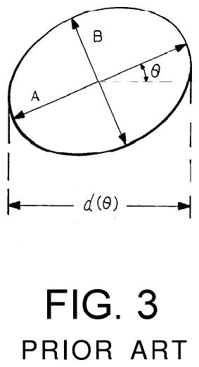

FIG. 1 is a side elevational view of a circular glass bottle 11.1 to be inspected, as disclosed in U.S. Pat. No. 4,500,203, which is incorporated by reference herein. FIG. 2 is a top plan view of the glass bottle 11.1 of FIG. 1. FIG. 3 is a top plan view similar to FIG. 2, but illustrating a glass bottle which has an oval cross-sectional shape. The bottles shown are examples of beverage bottles, and the corresponding description is incorporated by reference herein. To avoid duplication of reference numerals in other figures yet retain correspondence to the original description in U.S. Pat. No. 4,500,203, the number “0.1” has been added to each reference numeral.

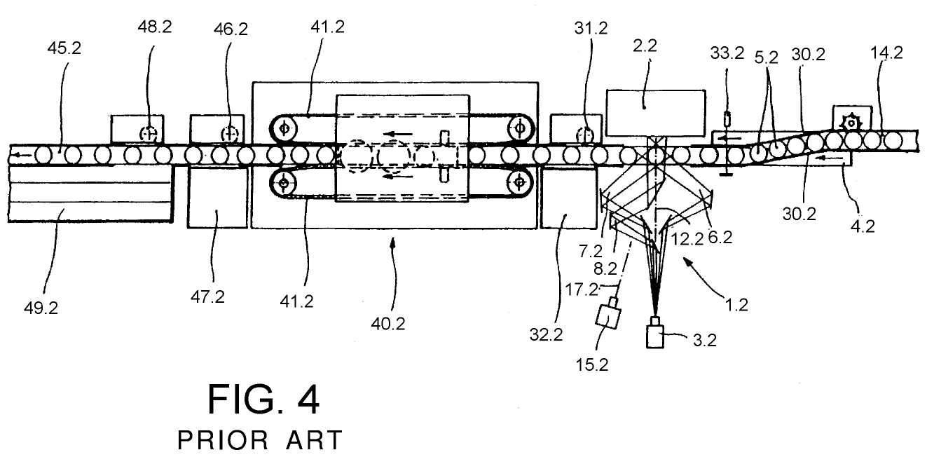

FIG. 4 shows an example of a beverage bottle handling machine, as disclosed in U.S. Pat. No. 5,729,340. The machine shown is an example of a beverage bottle handling device, and the corresponding description is incorporated by reference herein. To avoid duplication of reference numerals in other figures yet retain correspondence to the original description in U.S. Pat. No. 5,729,340, the number “0.2” has been added to each reference numeral. Referring to FIG. 4, bottles 5 are conveyed to the inspection machine on an infeed conveyor 14.2 which is driven continuously. The bottles 5.2 are transported in upright position on conveyor 14.2, the bottles being in abutting position at that time. Conveyor 14.2 may be a belt conveyor or a conveyor comprised as a series of plates that are linked together to form a closed loop. The bottles must be spaced from each other when they arrive at the inspection station 1.2. Accordingly, a pair of angulated guide rails guide bottles 5.2 onto a conveyor 4.2 which has a higher linear velocity than conveyor 14.2 so that a uniform width space is developed between consecutive bottles when they are passing through inspection station 1.2 on conveyor belt 4.2.

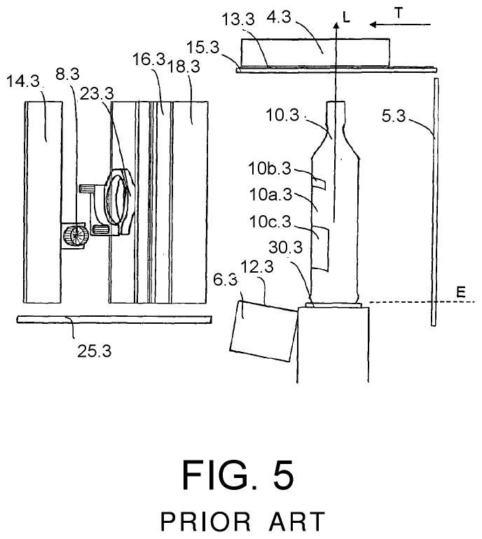

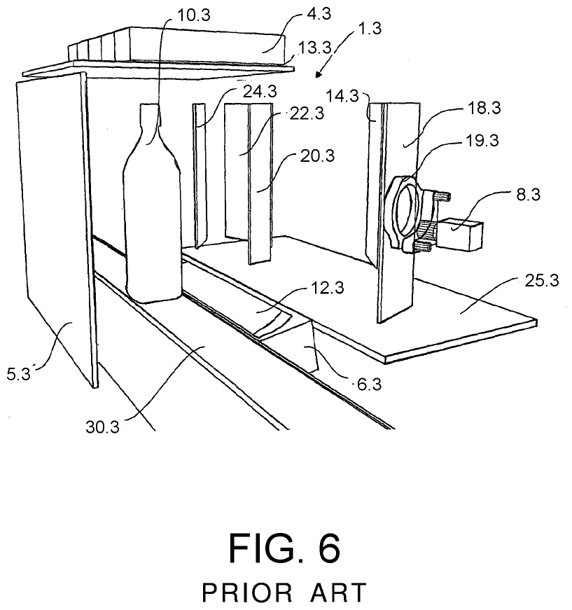

FIGS. 5 and 6 show views of a beverage bottle handling device according to EP 1985997. The device is shown as an example of a beverage bottle handling device, and the corresponding description is incorporated by reference herein. To avoid duplication of reference numerals in other figures yet retain correspondence to the original description in EP 1985997, the number “0.3” has been added to each reference numeral.

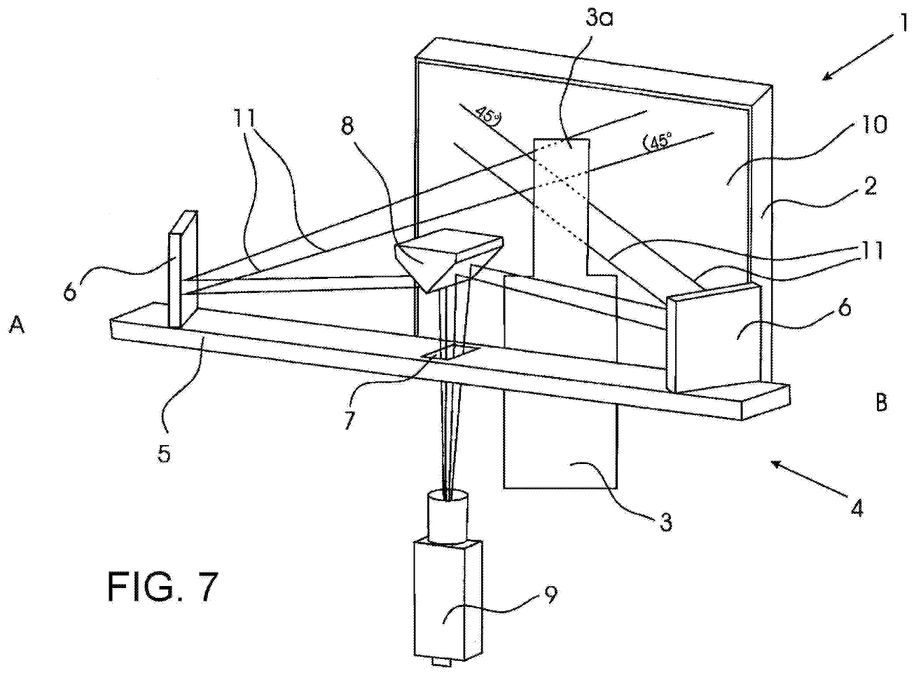

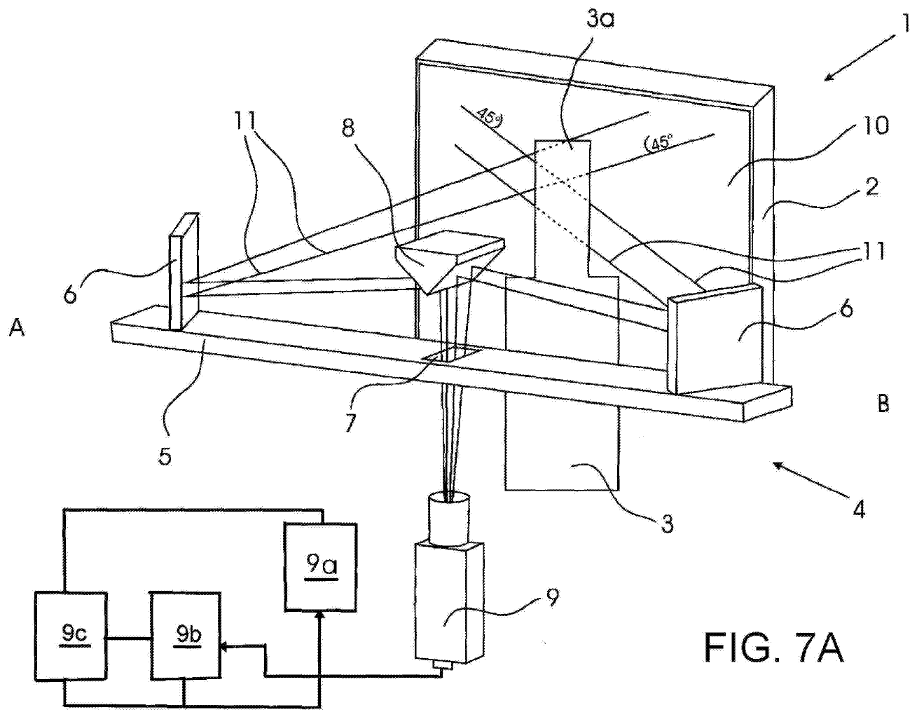

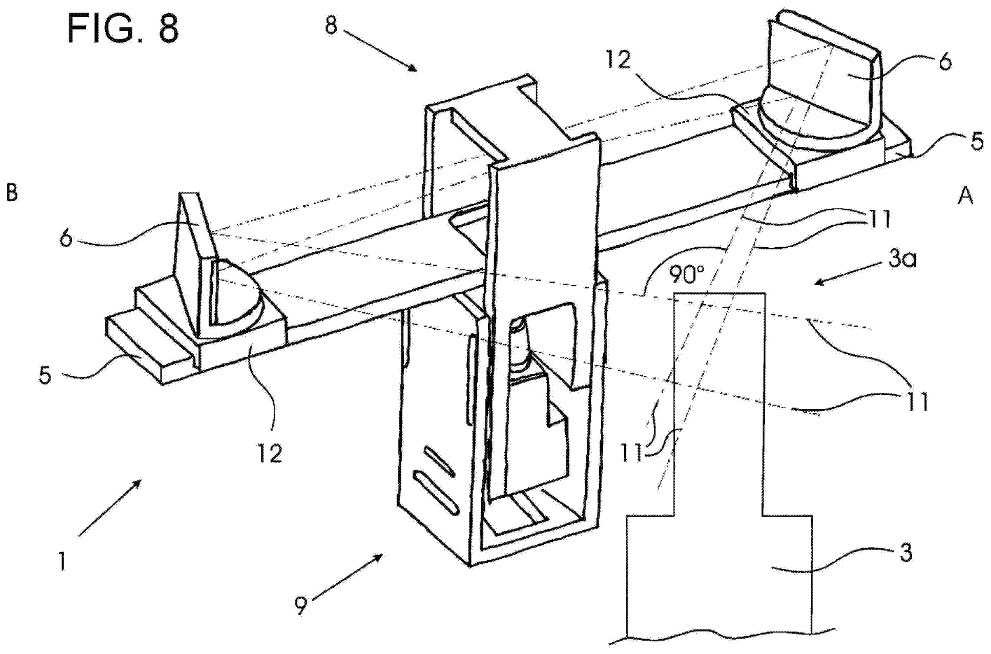

FIGS. 7 and 8 show a light transmission inspection device 1, which is arranged as integral to a container treatment station, configured as a transport star (not represented here), of a container processing device. The light transmission inspection device 1 comprises a lighting unit 2, which is provided as a light emitting element and in this case comprises a plurality of fluorescent lamps (not represented here). Ideally, as an alternative, a plurality of LED's (LED field or plate) or the like can be provided for.

The fluorescent lamps are covered by a transparent pane or plate, such as a glass or plastic pane, arranged on the outside of which is a lens 10 configured as a film lens. This is also the case, by analogy, with the exemplification with a plurality of LED lamps, wherein likewise a glass or other suitable lens carrier is likewise used. The film lens is configured in such a way that it aligns the light beams 11 emitted from the fluorescent lamps and penetrating into the film lens in such a way that the light beams 12 emerge at an angle of forty-five degrees to the lens surface in two spatial directions A, B, from the film lens.

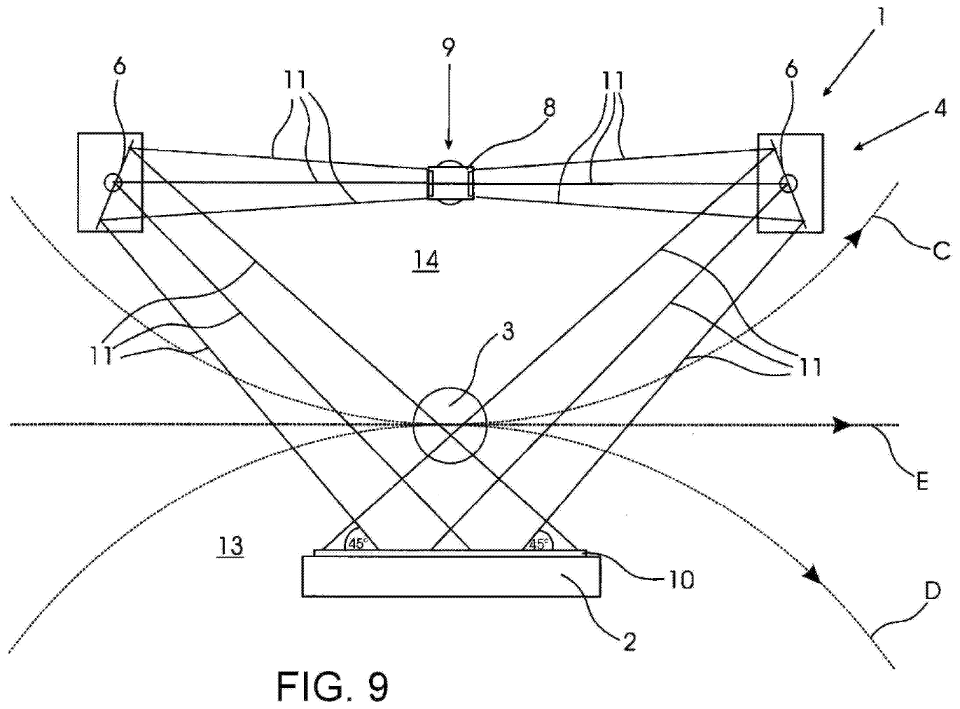

Upstream of the lighting unit 2 is a container 3, in this case a transparent bottle, arranged in a detection position. The bottle is arranged in the transport star, and is transported by this on a circular transport path (see FIG. 9) through the processing station.

The lighting unit 2 is arranged on a first side 13 of the transport path C, D, E. Arranged on a second side 14 of the transport path C, D, E, opposite the first side 13 of the transport path C, D, E is an optical unit 4. The optical unit 4 comprises a detection unit, configured as a camera 9, and three beam deflection elements. As beam deflection elements, two flat or other types of deflection mirrors 6, arranged spaced at a distance from one another, are arranged on a carrier body 5, and a deflection prism 8 arranged in the middle between the deflection mirrors 6. The deflection prism 6 is arranged perpendicularly or substantially perpendicularly above the camera 9.

The carrier body 5 of the optical unit 4 is arranged parallel or substantially parallel to the lighting unit 2, wherein the deflection prism 8 and the bottle 3, arranged in the detection position, are aligned perpendicular or substantially perpendicular to the film lens. That is to say, the deflection prism 8 and the bottle 3, located in the detection position, are arranged along a straight line, which stands perpendicular or substantially perpendicular to the film lens.

FIG. 7A shows the inspection system, as shown in FIG. 7, including a computer 9a operatively connected with the camera 9 and configured to detect and/or determine defects in structures of containers, such as beverage bottles.

The camera 9 may also be connected to an additional inspection system 9b and the container filling plant 9c which the inspection device 1 is part of. The additional inspection system 9b also forms part of the inspection device 1. The computer 9a may also be connected to additional inspection system 9b or the computer 9a may be only dedicated to the inspection system 1. There also may be additional connections between the components.

As can additionally be seen in FIG. 8, the deflection mirrors 6 are also secured to carrier elements 12, arranged adjustably on the carrier body 5. The carrier elements 12 are arranged adjustably in the form of carriages along a longitudinal axis of the carrier body 5, and can therefore be adjusted depending on the angle a of the light beams 11. The deflection mirrors 6 are secured on the carrier elements 12. The carrier elements 12 can additionally form the mounting for the deflection mirrors 6 or, respectively, the carrier of the defection mirrors. In this mounting, which is not represented here in any greater detail, the deflection mirrors 6 are capable of rotating about their perpendicular or substantially perpendicular longitudinal axis.

By way of supplement, the camera 9 can also be mounted in the form of a carriage, or at least displaceable vertically, and arranged in such a way that, overall, an extremely fast inspection system, capable of versatile adjustment, is provided, which essentially ensures and/or promotes short conversion and adjustment times.

If required and/or desired, one or a plurality of motorized drives can be provided, in order in one possible exemplification to arrange the horizontal adjustment of the carrier elements 12 (if appropriate in synchrony), but also to arrange for the angle adjustment of the deflection mirrors 6 or the displacement of the camera 9.

FIG. 9 shows the light transmission inspection device 1 from FIGS. 7 and 8. In this situation, the lighting body 2 is represented with the lens 10 configured as a film lens such as a Fresnel's film lens.

Starting from the surface of the film lens, the light beams 11 are emitted obliquely at an angle a of about forty-five degrees to the lens surface 10a in the direction of the deflection mirrors 6 and therefore in two different spatial directions A, B. In this situation, the light beams 11 transilluminate the container 3, in this case the mouth region 3a of the container 3.

At the moment of the transillumination, the container 3 is in a detection position on the transport path C, D, E. Here it is located on the circular transport path C, which leads around the optical unit 4. As an alternative, the container 3 can also be located on the circular transport path D around the lighting unit 2 or on the linear running transport path E.

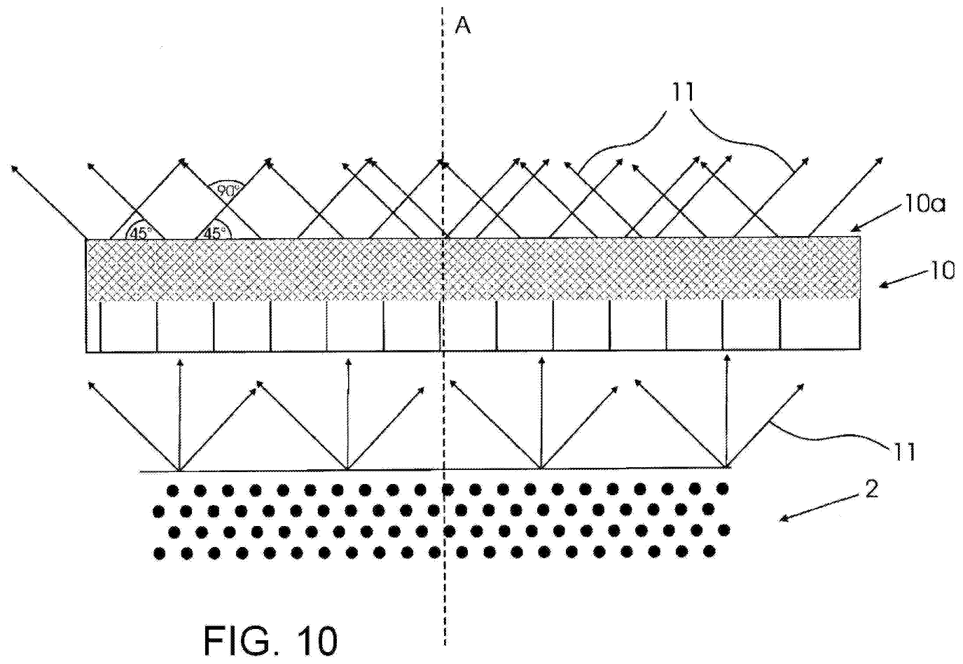

FIG. 10 shows a cross-section through the lighting body 2 and the lens 10. For better representation, the lens 10 and the lighting body 2 are represented here as being spaced at a distance from one another. The lens 10 can also be arranged directly adjacent to the lighting body 2. The lens 10 is configured as a film lens, and is structured as two-layered.

The light beams 11 emitted by the lighting unit 2 in this situation exhibit a diffuse distribution. They penetrate into the film lens, and, when running through the two lens layers, are aligned in such a way that they emerge exclusively at angle of forty-five degrees to the lens surface 10a in two different spatial directions A, B. The emerging light beams 11, radiating into the different spatial directions, therefore exhibit an angle of ninety degrees to one another.

In operation, the bottle 3 is transported, for example, by the transport star on the circular transport path C. As soon as the bottle 3 reaches the detection position (as represented in FIGS. 7-9), a transmitted light image of the mouth region 3a is produced by the camera 9. For this purpose, the camera 9 detects the light beams 11, which, starting from the lighting body 2, are emitted through the film lens 10 in two oblique spatial directions A, B, at an angle of forty-five degrees to the deflection mirrors 6. In this situation they transilluminate the mouth region 3a of the bottle 3, and, depending, for example, on the thickness of the container material, are absorbed in different amounts. The shadow images of the mouth region 3a which are imaged on the deflection mirror 6 appear, for example, in one possible exemplification dark and with clear outlines.

From the deflection mirror 6, the shadow images are passed on to the deflection prism 8, and from the deflection prism 8 through the light aperture 7 into the detection region of the camera 9. The camera 9 detects both shadow images and passes them, for example in the form of a data signal, to an evaluation unit (not represented here), with which a reference/actual comparison can be carried out.

In this situation, the alignment of the film lens 2 in a preferred exemplification is such that the course of the beam, without vertical deflection, runs at least as far as the deflection mirror 6. Ideally, in one exemplification, the deflection mirrors 6 and the deflection prism 8 are also arranged in such a way that the course of the beam does not incur any vertical deflection between the film lens 2, deflection 6, and the deflection prism 8.

Since the container 3 is located on a circular track, it is slightly deflected relative to its perpendicular or substantially perpendicular longitudinal axis. Due to this deflection of the mouth region 3a of the bottle 2, arranged as far as possible horizontally to the longitudinal axis, and the oblique transillumination of the mouth region 3a with light beams 11, irradiating into two different spatial directions A, B, the two transmitted light images of the mouth region 3a exhibit an inclination.

The evaluation unit evaluates the transmitted light images transferred by the camera 9 and determines, with the aid of the two inclination angles of the mouth region 3a, the deflection angle of the bottle 3.

As an alternative or supplement, it is also possible, for example, with the transmitted light image, for the outer edges of a label, a marking, or also an embossing to be detected, and their position on the bottle 3 to be determined. As an alternative, these transmitted light images can also be used to determine the deflection of the bottle 3.

It is also possible, for example, for a bottle seam recognition system to be arranged, which detects the position of the bottle seam on the bottle, and, by means of a comparison with the deflection of the bottle 3 determined by the light transmission inspection device, then determines the exact actual or general position of the bottle seam on the bottle 3.

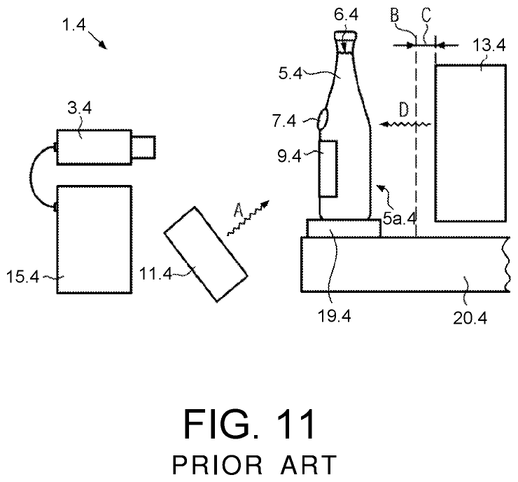

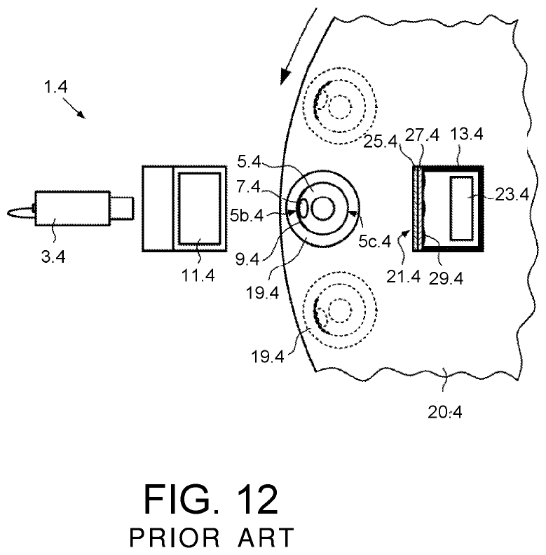

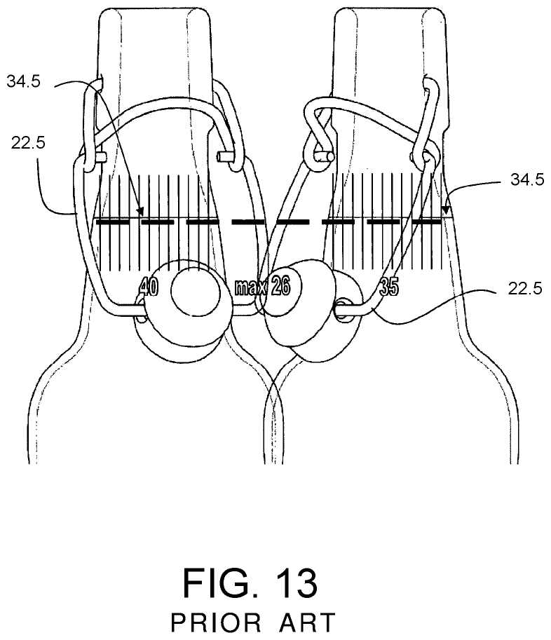

FIGS. 11 and 12 show views of a beverage bottle handling device according to EP 2251678. The device is shown as an example of a beverage bottle handling device, and the corresponding description is incorporated by reference herein. To avoid duplication of reference numerals in other figures yet retain correspondence to the original description in EP 2251678, the number “0.4” has been added to each reference numeral.

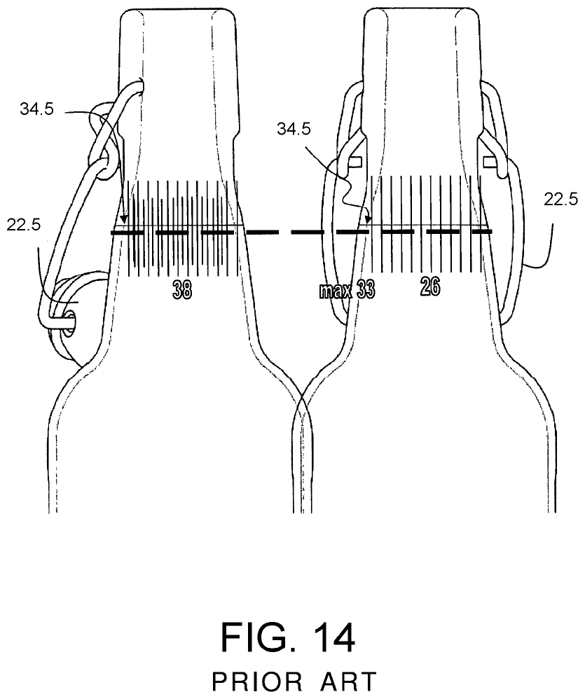

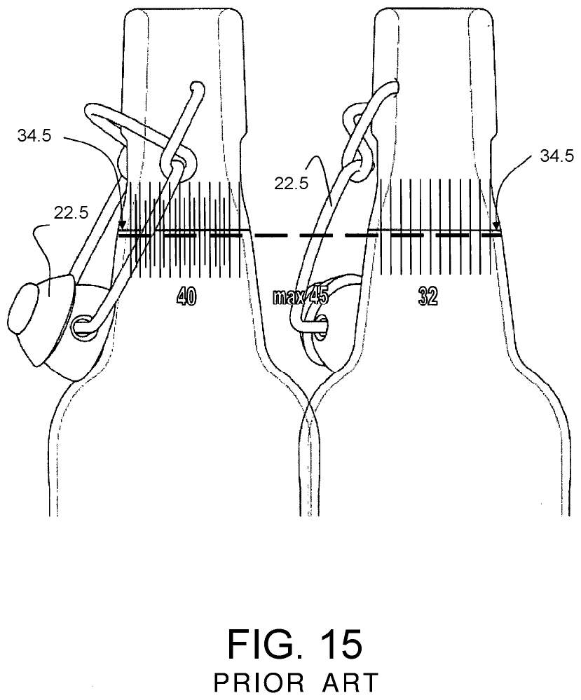

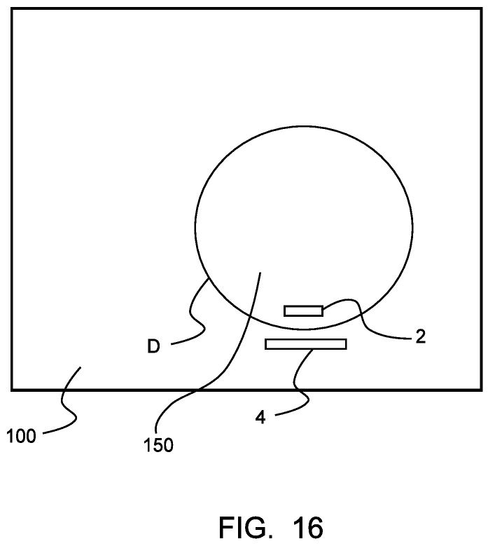

FIGS. 13-15 show views of a beverage bottle according to DE 102007054657. The items shown are an example of a beverage bottle, and the corresponding description is incorporated by reference herein. To avoid duplication of reference numerals in other FIGS. yet retain correspondence to the original description in DE 102007054657, the number “0.5” has been added to each reference numeral.

The present application relates to a light transmission inspection device for detecting structures of a container, like a bottle, having a lighting unit arranged at a first side of a transport path for the container for transilluminating at least one container portion, and having an optical unit arranged on a second side of the transport path for detecting a transmitted light image of the container portion. In order to provide an improved inspection device for detecting structures of a container during the movement thereof on a transport path, according to the present application a lens for the orientation of the light beams emitted by the lighting unit is arranged on the lighting unit.

One feature or aspect of an exemplification is believed at the time of the filing of this patent application to possibly reside broadly in a light transmission inspection device for detecting structures of a container 3, such as a bottle, comprising a lighting unit 2 arranged at a first side of a transport path for the container 3 for transilluminating at least one container portion, and an optical unit 4 arranged on a second side of the transport path, for detecting a transmitted light image of the container portion, wherein a lens 10 is arranged at the lighting unit 2 for the alignment of the light beams 11 emitting from the lighting unit 2, wherein the lens 10 is a film lens, which aligns the light beams 11 in at least one spatial direction A, B which is not perpendicular or substantially perpendicular to the transport path.

Another feature or aspect of an exemplification is believed at the time of the filing of this patent application to possibly reside broadly in the light transmission inspection device, wherein the lens 1 aligns the light beams 11 in two different spatial directions A, B.

Yet another feature or aspect of an exemplification is believed at the time of the filing of this patent application to possibly reside broadly in the light transmission inspection device, wherein the optical unit 4 comprises at least one detection unit, in one possible exemplification a camera 9, and at least two beam deflection elements deflecting the light beams 11.

Still another feature or aspect of an exemplification is believed at the time of the filing of this patent application to possibly reside broadly in the light transmission inspection device, wherein an evaluation unit is arranged, which compares a reference or target position and/or a reference or target marking of the container 3 with the actual position and/or actual marking detected by the optical unit 4.

A further feature or aspect of an exemplification is believed at the time of the filing of this patent application to possibly reside broadly in the light transmission inspection device, wherein a bottle seam detection system with a second optical system for detecting a position of the bottle seam is arranged at the bottle 3.

Another feature or aspect of an exemplification is believed at the time of the filing of this patent application to possibly reside broadly in the light transmission inspection device, wherein it comprises a lighting unit 2 which is configured as a plurality of LED lights, and wherein the film lens 10 is carried on or at a transparent pane or plate or that the latter is covered by it.

One feature or aspect of an exemplification is believed at the time of the filing of this patent application to possibly reside broadly in a container light transmission system configured to transmit light through at least one portion of a container and to provide images to an inspection device for detect structures of a container, such as a bottle, said system comprising: a lighting unit, configured to be arranged at a first side of a transport path of an apparatus to transport a container, and configured to shine light through at least one portion of a container; an optical unit, configured to be disposed on a second side of the transport path of the apparatus, to detect a transmitted light image of at least one container portion; wherein a lens is disposed at the lighting unit to align the light beams emitted from the lighting unit; wherein the lens is a film lens, such as a Fresnel's lens, which aligns the light beams so as not to be perpendicular to a transport path of a container.

Another feature or aspect of an exemplification is believed at the time of the filing of this patent application to possibly reside broadly in the container light transmission system, wherein the lens aligns the light beams in two different spatial directions.

Yet another feature or aspect of an exemplification is believed at the time of the filing of this patent application to possibly reside broadly in the container light transmission system, wherein said film lens comprises a Fresnel's lens to align the light beams at one of: A) about ninety degrees with respect to one another; B) wherein one light beam is about forty-five degrees to the film surface of the Fresnel's lens and the light beam is about forty-five degrees to the film surface such that the beams are about ninety degrees with respond to the film surface of the Fresnel's lens.

Still another feature or aspect of an exemplification is believed at the time of the filing of this patent application to possibly reside broadly in the container light transmission system, wherein said Fresnel's lens comprises lens portions configured to direct the light beams at about ninety degrees to one another.

A further feature or aspect of an exemplification is believed at the time of the filing of this patent application to possibly reside broadly in the container light transmission system, wherein the optical unit comprises at least one detection unit, in particular a camera, and at least two beam deflection elements deflecting the light beams.

Another feature or aspect of an exemplification is believed at the time of the filing of this patent application to possibly reside broadly in the container light transmission system, including an evaluation unit, which compares a reference or target position and/or a reference or target marking of the container with the actual position and/or actual marking detected by the optical unit.

Yet another feature or aspect of an exemplification is believed at the time of the filing of this patent application to possibly reside broadly in the container light transmission system, including a bottle seam detection system with a second optical system for detecting a position of the bottle seam disposed at the bottle.

Still another feature or aspect of an exemplification is believed at the time of the filing of this patent application to possibly reside broadly in the container light transmission system, including a bottle seam detection system with a second optical system for detecting a position of the bottle seam disposed at the bottle.

A further feature or aspect of an exemplification is believed at the time of the filing of this patent application to possibly reside broadly in the container light transmission system, wherein it comprises a lighting unit which is configured as a plurality of LED lights, and wherein the film lens is carried on or at a transparent pane or plate or that the latter is covered by it.

Another feature or aspect of an exemplification is believed at the time of the filing of this patent application to possibly reside broadly in the light container transmission system, in combination with an apparatus to transport a container to which said lighting unit is arranged at the first side of a transport path of said transport apparatus.

Yet another feature or aspect of an exemplification is believed at the time of the filing of this patent application to possibly reside broadly in the light container transmission system, wherein said optical unit is disposed on the second side of the transport path of the transport apparatus opposite the first side.

One feature or aspect of an exemplification is believed at the time of the filing of this patent application to possibly reside broadly in a method of using a container light transmission system and transmitting light through at least one portion of a container and providing images to an inspection device for detect structures of a container, such as a bottle, said method comprising: disposing a lighting unit at a first side of a transport path of an apparatus to transport a container, and shining light through at least one portion of a container during transporting; disposing an optical unit on a second side of the transport path of the apparatus, and detecting a transmitted light image of at least one container portion being transported; disposing a lens at the lighting unit and aligning the light beams emitted from the lighting unit; disposing the lens which is a film lens, such as a Fresnel's lens, and aligning the light beams going through a container so as not to be perpendicular to a transport path of a container.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

The following patents, patent applications, patent publications, and other documents, except of the exceptions indicated herein, are hereby incorporated by reference as if set forth in their entirety herein except for the exceptions indicated herein, as follows: DE 10 2004 040 164 A1, having the following English translation of the original German title “Device for detecting structures, such as profiles or stampings, on bodies of bottles or similar containers”, published on Mar. 2, 2006; and DE 10 2008 053 876 A1, having the original German title “Flaschennaht- and Embossingausrichtung”, published on May 6, 2010.

All of the patents, patent applications, patent publications, and other documents, except for the exceptions indicated herein, are hereby incorporated by reference as if set forth in their entirety herein except for the exceptions indicated herein, as follows: DE2617457 (A1), having the original German title “VERFAHREN ZUM ERZEUGEN EINES SICHTBILDES EINES ZU PRUEFENDEN GEGENSTANDES MITTELS DURCHSTRAHLUNG SOWIE OPTISCHE PRUEFVORRICHTUNG”, and published on Nov. 4, 1976; DE1 02007059732 (A1), having the German title “Lichtemittierende Vorrichtung”, published on Jun. 18, 2009; and DE69321925 (T2), having the following English translation of the original German title “Machine for video inspection of glass containers with intersecting light beams”, published on Mar. 25, 1999.

All of the patents, patent applications, patent publications, and other documents, except for the exceptions indicated herein, are hereby incorporated by reference as if set forth in their entirety herein except for the exceptions indicated herein, as follows: U.S. Pat. No. 4,500,203 (A), having the title “Method and apparatus for inspecting articles”, published on Feb. 19, 1985; DE10140010 (A1), having the following English translation of the German title “METHOD AND DEVICE FOR INSPECTING FILLED, CLOSED BOTTLES, IN PARTICULAR IN THE LATERAL WALL AREA NEAR THE BASE”, published on Mar. 13, 2003; US2012127754 (A1), having the title “LIGHT SOURCE MODULE AND ILLUMINATION APPARATUS”, published on May 24, 2012; DE1 02007054657 (A1), having the following English translation of the German title “Visualization and/or examination arrangement for e.g. glass bottle, has reflector system providing images of sample from different directions, where images are subjectable to image analysis and/or image comparison in image evaluation device”, published on Jul. 3, 2008; DE202008003953 (U1), having the original German title “Optischer Sensor”, published on Jul. 10, 2008; EP2251678 (A2), having the English translation of the original German title “Inspection device for recognising embossing and/or labels on transparent containers, in particular drink containers”, published on Nov. 17, 2010; EP2290355 (A2), having the English translation of the original German title “Device and method for inspecting labelled containers”, published on Mar. 2, 2011; EP1 985997 (A1), having the English translation of the German title “Inspection device for containers”, published on Oct. 29, 2008; U.S. Pat. No. 5,729,340 (A), having the title “Bottle inspection machine”, published on Mar. 17, 1998; and DE202012103660 (U1), having the German title “Leuchte, insbesondere Scheinwerfer”, published on Jan. 7, 2014.

Federal Republic of Germany Patent Application No. 10 2014 102 450.8, filed on Feb. 25, 2014, and International Application No. PCT/EP2015/053656, filed on Feb. 20, 2015, having WIPO Publication No. WO 2015/128264, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. § 1.72(b). As stated in 37 C.F.R. § 1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

1. A beverage bottle handling arrangement comprising:
a beverage bottle filling machine being configured to fill beverage bottles with a liquid beverage;
said beverage bottle filling machine comprising
a first rotatable transport star configured and disposed to hold beverage bottles on the perimeter thereof, and configured to move beverage bottles by rotating movement along a first circular transport path;
a beverage bottle labeling machine configured to label beverage bottles;
said beverage bottle labeling machine comprising
a second rotatable transport star configured and disposed to hold beverage bottles on the perimeter thereof, and configured to move beverage bottles by rotating movement along a second circular transport path;
a third rotatable transport star configured and disposed to hold beverage bottles on the perimeter thereof, and configured to move beverage bottles by rotating movement along a third circular beverage bottle transport path;
at least one beverage bottle inspection arrangement being configured to inspect beverage bottles;
said at least one beverage bottle inspection arrangement being disposed at and connected to at least one of said first, second, and third rotatable transport stars;
said at least one beverage bottle inspection arrangement comprising a first beverage bottle inspection device and a second beverage bottle inspection device being disposed opposite one another and spaced apart such that beverage bottles can be moved therebetween;
said first inspection device comprising a housing and a lighting unit disposed therein and configured to illuminate beverage bottles with light emitted therefrom;
said first inspection device being mounted on or adjacent its corresponding transport star, inside the perimeter of its corresponding transport star, and adjacent to but out of the path of beverage bottles being moved thereby;
said second inspection device comprising an optical unit being configured to receive light passing through beverage bottles from said lighting unit; and
said second inspection device being disposed outside the perimeter of its corresponding transport star and adjacent to but out of the path of beverage bottles being moved thereby.

2. (canceled)

3. The beverage bottle handling arrangement according to claim 1, wherein:
said housing being substantially planar and having a length, width, and thickness; and
said thickness of said housing is substantially smaller than the length and width of said housing.

4. (canceled)

5. The beverage bottle handling arrangement according to claim 3, wherein said first inspection device is disposed at substantially the same height as said second inspection device.

6-7. (canceled)

8. The beverage bottle handling arrangement according to claim 1, wherein said first inspection device is disposed at substantially the same height as said second inspection device.

9-12. (canceled)

13. The beverage bottle handling arrangement according to claim 5, wherein:
said housing of said first inspection device comprises a single planar lens disposed between said lighting unit and beverage bottles passing thereby; and
said planar lens is configured to align light from said lighting unit passing therethrough into two different, intersecting, directions to illuminate beverage bottles passing thereby from two sides.

14. The beverage bottle handling arrangement according to claim 13, wherein said optical unit comprises a camera and a mirror arrangement to reflect light that has passed through beverage bottles to said camera to permit detection of beverage bottle physical characteristics comprising embossings, labels, and bottle seams.

15. The beverage bottle handling arrangement according to claim 14, wherein:
said mirror arrangement comprises a support structure, and a first mirror and a second mirror mounted on said support structure;
said first mirror is rotatable on said support structure and/or is movable to different positions on said support structure; and
said second mirror is rotatable on said support structure and/or is movable to different positions on said support structure.

16. A beverage bottle handling arrangement comprising a beverage bottle filling machine to fill beverage bottles with a liquid beverage or a beverage bottle labeling machine to label beverage bottles or a beverage bottle handling machine, said beverage bottle handling arrangement comprising:
a rotatable transport star configured and disposed to hold beverage bottles on the perimeter thereof, and configured to move beverage bottles by rotating movement along a circular beverage bottle transport path;
a beverage bottle inspection arrangement being disposed at and connected to said rotatable transport star;
said beverage bottle inspection arrangement comprising a first inspection device and a second inspection device being disposed opposite one another and spaced apart such that beverage bottles can be moved therebetween;
said first inspection device comprising a housing and a lighting unit disposed therein and configured to illuminate beverage bottles with light emitted therefrom;
said first inspection device being mounted on or adjacent said rotatable transport star, and disposed inside the perimeter of said rotatable transport star, and adjacent to but out of the path of beverage bottles being moved thereby;
said second inspection device comprising an optical unit being configured to receive light passing through beverage bottles from said lighting unit; and
said second inspection device being disposed outside the perimeter of said rotatable transport star and adjacent to but out of the path of beverage bottles being moved thereby.

17. The beverage bottle handling arrangement according to claim 16, wherein:
said housing being substantially planar and having a length, width, and thickness; and
said thickness of said housing is substantially smaller than the length and width of said housing.

18. The beverage bottle handling arrangement according to claim 17, wherein said first inspection device is disposed at substantially the same height as said second inspection device.

19. The beverage bottle handling arrangement according to claim 18, wherein:
said housing of said first inspection device comprises a single planar lens disposed between said lighting unit and beverage bottles passing thereby; and
said planar lens is configured to align light from said lighting unit passing therethrough into two different, intersecting, directions to illuminate beverage bottles passing thereby from two sides.

20. The beverage bottle handling arrangement according to claim 19, wherein said optical unit comprises a camera and a mirror arrangement to reflect light that has passed through beverage bottles to said camera to permit detection of beverage bottle physical characteristics comprising embossings, labels, and bottle seams.

21. The beverage bottle handling arrangement according to claim 20, wherein:
said mirror arrangement comprises a support structure, and a first mirror and a second mirror mounted on said support structure;
said first mirror is rotatable on said support structure and/or is movable to different positions on said support structure; and
said second mirror is rotatable on said support structure and/or is movable to different positions on said support structure.

22. The beverage bottle handling arrangement according to claim 16, wherein:
said housing of said first inspection device comprises a single planar lens disposed between said lighting unit and beverage bottles passing thereby; and
said planar lens is configured to align light from said lighting unit passing therethrough into two different, intersecting, directions to illuminate beverage bottles passing thereby from two sides.

23. The beverage bottle handling arrangement according to claim 22, wherein said optical unit comprises a camera and a mirror arrangement to reflect light that has passed through beverage bottles to said camera to permit detection of beverage bottle physical characteristics comprising embossings, labels, and bottle seams.

24. The beverage bottle handling arrangement according to claim 23, wherein:
said mirror arrangement comprises a support structure, and a first mirror and a second mirror mounted on said support structure;
said first mirror is rotatable on said support structure and/or is movable to different positions on said support structure; and
said second mirror is rotatable on said support structure and/or is movable to different positions on said support structure.

25. In a beverage bottle handling arrangement comprising a beverage bottle filling machine to fill beverage bottles with a liquid beverage or a beverage bottle labeling machine to label beverage bottles or a beverage bottle handling machine, a beverage bottle inspection arrangement being configured to be disposed at and connected to a rotatable transport star configured to hold beverage bottles on the perimeter thereof, said beverage bottle inspection arrangement comprising:
a first inspection device and a second inspection device being disposed opposite one another and spaced apart such that beverage bottles can be moved therebetween;
said first inspection device comprising a housing and a lighting unit disposed therein and configured to illuminate beverage bottles with light emitted therefrom;
said first inspection device being configured to be mounted on or adjacent said rotatable transport star, and disposed inside the perimeter of said rotatable transport star, and adjacent to but out of the path of beverage bottles being moved thereby;
said second inspection device comprising an optical unit being configured to receive light passing through beverage bottles from said lighting unit; and
said second inspection device being configured to be disposed outside the perimeter of said rotatable transport star and adjacent to but out of the path of beverage bottles being moved thereby.
